(19) United States
(12) Patent Application Publication
(10) Pub. No.: US 2011/0307444 A1
(43) Pub. Date: Dec. 15, 2011

(54) REPLICATING SERVER CONFIGURATION DATA IN DISTRIBUTED SERVER ENVIRONMENTS

(75) Inventors: Shaun Cox, Redmond, WA (US); Serkan Kutan, New York, NY (US); Erdinc Basci, Redmond, WA (US)

(73) Assignee: MICROSOFT CORPORATION, Redmond, WA (US)

(21) Appl. No.: 12/813,726

(22) Filed: Jun. 11, 2010

(51) Int. Cl. G06F 17/30

(52) U.S. Cl. 707/625; 707/634; 707/E17.005; 707/E17.007

(57) ABSTRACT

Components of a distributed server system are configured through replicating configuration data from a central configuration store to server machines. Configuration data is placed in globally identifiable containers or batches. A master replication agent service and a file transfer agent service running in conjunction with a central data storage unit are responsible for replicating configuration data within the batches to other machines in the deployment. A replica replication agent service running on the individual machines updates its own state and posts its latest status back to the central replication services, which upon receiving the status from every machine pushes changes to synchronize the machines with the latest configuration in central store.

### BACKGROUND

As an alternative to Public Switched Telephone Network (PSTN) systems, cellular phone networks have proliferated over the last decades, where users with cellular phones have access to one or more networks at almost any location. Also a recent development is the wide spread use of Voice over IP (VOIP) telephony, which uses internet protocol (IP) over wired and wireless networks. With the availability of such diverse types of communication networks and devices capable of taking advantage of various features of these networks, enhanced communication systems bring different communication networks together providing until now unavailable functionality such as combining various modes of communication (e.g. instant messaging, voice calls, video communications, etc.). This technology is also referred to as unified communications (UC). A network of servers manages end devices capable of handling a wide range of functionality and communication while facilitating communications between the more modern unified communication network devices and other networks (e.g. PSTN, cellular, etc.).

Distributed server components in enhanced communication systems and similar environments expose certain configurations for system administrators to tailor server behavior according to their needs. Since such systems may potentially include relatively large number of machines, providing tailored configuration individually to every machine may not be practical.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a mechanism for configuring components of a distributed server system through replicating configuration data from a central configuration store to server machines. According to some embodiments, configuration data may be placed in globally identifiable containers or batches. A master replication agent service and a file transfer agent service running in conjunction with a central data storage unit may be responsible for replicating configuration data within the batches to other machines in the deployment. A replica replication agent service running on the individual machines may update its own state and post its latest status back to the central replication services, which upon receiving the status from every machine may push changes to synchronize the machines with the latest configuration in central store.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating an example enhanced communications system such as a UC system, where embodiments may be implemented for replicating server configuration in distributed server systems;

FIG. 2 illustrates the master side of an example replication model of structured document store layers according to embodiments;

FIG. 3 illustrates the replica side of an example replication model of structured document store layers according to embodiments;

FIG. 4 is an example replication database diagram for replicating server configuration in a distributed server system;

FIG. 5 is a block diagram of an example computing operating environment, where embodiments may be implemented; and

FIG. 6 illustrates a logic flow diagram for a process of replicating server configuration in a distributed server system according to embodiments.

### DETAILED DESCRIPTION

As briefly described above, configuration data for a distributed server system may be placed in globally identifiable batches. A master replication agent service and a file transfer agent service running in conjunction with a central data storage unit may be responsible for replicating the configuration data within the batches to other machines in the deployment. A replica replication agent service running on the individual machines may update its own state and post its latest status back to the central replication services, which upon receiving the status from every machine may push changes to synchronize the machines with the latest configuration in central store. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing distributed server systems. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below. The term “site” as used herein refers to a geographical location and may include data centers, branch offices, and similar communication sub-systems. Furthermore, the term cluster refers to a group of physical and/or virtual servers, which may provide the same service to a client in a transparent manner (i.e., the client sees a single server, while the cluster may have a plurality of servers).

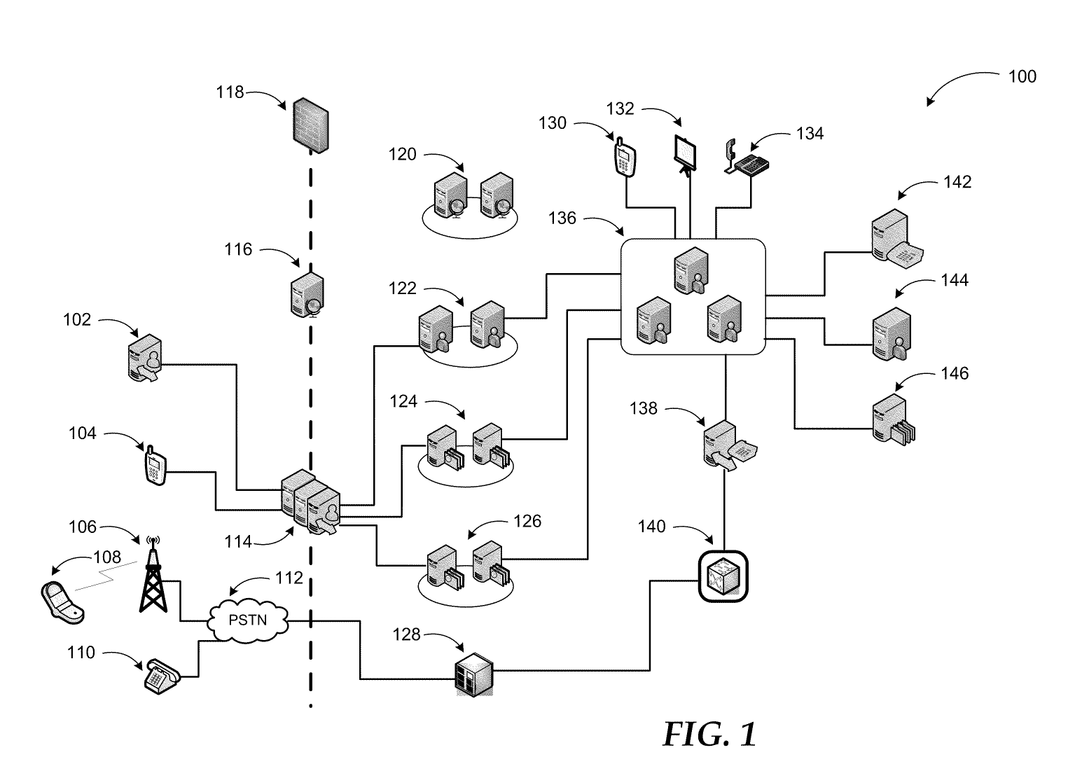

FIG. 1 includes diagram 100 illustrating an example enhanced communications system such as a UC system, where embodiments may be implemented for replicating server configuration in distributed server systems. A unified communication (UC) system is an example of modern communication systems with a wide range of capabilities and services that can be provided to subscribers. A unified communication system is a real-time communications system facilitating email exchange, instant messaging, presence, audio-video conferencing, web conferencing, and similar functionalities.

In a unified communication (UC) system such as the one shown in diagram 100, users may communicate via a variety of end devices 130, 132, 134, which are client devices of the UC system. Each client device may be capable of executing one or more communication applications for voice communication, video communication, instant messaging, application sharing, data sharing, and the like. In addition to their advanced functionality, the end devices may also facilitate traditional phone calls through an external connection such as through Private Branch Exchange (PBX) 128 to a Public Switched Telephone Network (PSTN) 112. Further communications through PSTN 112 may be established with a telephone 110 or cellular phone 108 via cellular network tower 106. End devices 130, 132, 134 may include any type of smart phone, cellular phone, any computing device executing a communication application, a smart automobile console, and advanced phone devices with additional functionality.

The UC system shown in diagram 100 may include a number of servers performing different tasks. For example, edge servers 114 may reside in a perimeter network and enables connectivity through UC network(s) with other users such as remote user 104 or federated server 102 (for providing connection to remote sites). A Hypertext Transfer Protocol (HTTP) reverse protocol proxy server 116 may also reside along the firewall 118 of the system. Edge servers 114 may be specialized for functionalities such as access, web conferencing, audio/video communications, and so on. Inside the firewall 118, a number of clusters for distinct functionalities may reside. The clusters may include web servers for communication services 120, director servers 122, web conferencing servers 124, and audio/video conferencing and/or application sharing servers 126. Depending on provided communication modalities and functionalities, fewer or additional clusters may also be included in the system.

The clusters of specialized servers may communicate with a pool of registrar and user services servers 136. The pool of registrar and user services servers 136 is also referred to as a data center. A UC system may have one or more data centers, each of which may be at a different site. Registrar servers in the pool register end points 130, 132, and 134, and facilitate their communications through the system acting as home servers of the end points. User services server(s) may provide presence, backup monitoring, and comparable management functionalities. Pool 136 may include a cluster of registrar servers. The registrar servers may act as backups to each other. The cluster of registrar servers may also have backup clusters in other data servers as described later.

Mediation server 138 mediates signaling and media to and from other types of networks such as a PSTN or a cellular network (e.g. calls through PBX 128) together with IP-PSTN gateway 140. Mediation server 138 may also act as a Session Initiation Protocol (SIP) user agent. In a UC system, users may have one or more identities, which is not necessarily limited to a phone number. The identity may take any form depending on the integrated networks, such as a telephone number, a Session Initiation Protocol (SIP) Uniform Resource Identifier (URI), or any other identifier. While any protocol may be used in a UC system, SIP is a commonly used method. SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer.

Additional components of the UC system may include messaging server 142 for processing voicemails and similar messages, application server 144 for specific applications, and archiving server 146. Each of these may communicate with the data center pool of registrar and user services servers 136. Various components of the system may communicate using protocols like SIP, HTTP, and comparable ones.

As mentioned previously, UC system is a distributed server system. Individual components (e.g. servers) of the system may be configured by replicating configuration data from a central configuration store to server machines using globally identifiable batches. A master replication agent service and a file transfer agent service running in conjunction with a central data storage unit may receive status from every machine and push changes to synchronize the machines with the latest configuration in central store.

In a system according to embodiments, if for any reason changes cannot be replicated to a particular machine for certain amount of time, that machine may get fully synchronized with the master configuration store the next time the replication happens successfully. Thus, configuration of the machines is not incremental or accumulated. The replication system does not rely on storing placeholders for deleted objects. As a result, there is no upper limit on how long a particular machine can be offline. Even after years of being not up to date, when a replica machine becomes available, it may be synchronized with the master configuration regardless of the machine's previous state. Furthermore, a configuration document is replicated or not. Thus, there is no state where replica machine has invalid/partial document. This characteristic makes it possible to validate the schema/semantics of each document at anytime.

A replication according to embodiments is effective in data transfer load. Once a machine becomes up-to-date with the master configuration, frequent communication between replication agents is not needed. Moreover, if there is a change in configuration store, only the necessary data is transferred (not the entire configuration) required to synchronize the replica machines with the master configuration store. According to other embodiments, various ways of transferring configuration data to other machines may be employed. The master replicator agent service may generate a compressed file (e.g. a zip file) required for a particular machine. The file transfer agent may then employ file copy, http protocol, or similar method to transfer the compressed file. The compressed file may even be manually copied to the machines. Furthermore, the file transfer agent service may be completely replaced by other custom implementations.

While the example system in FIG. 1 has been described with specific components such as registrar servers, mediation servers, A/V servers, and similar devices, embodiments are not limited to these components or system configurations and can be implemented with other system configuration employing fewer or additional components. Replication of configuration data in distributed server systems may also be distributed among the components of the systems differently depending on component capabilities and system configurations. Furthermore, embodiments are not limited to unified communication systems. The approaches discussed here may be applied to any data exchange network environment with distributed servers using the principles described herein.

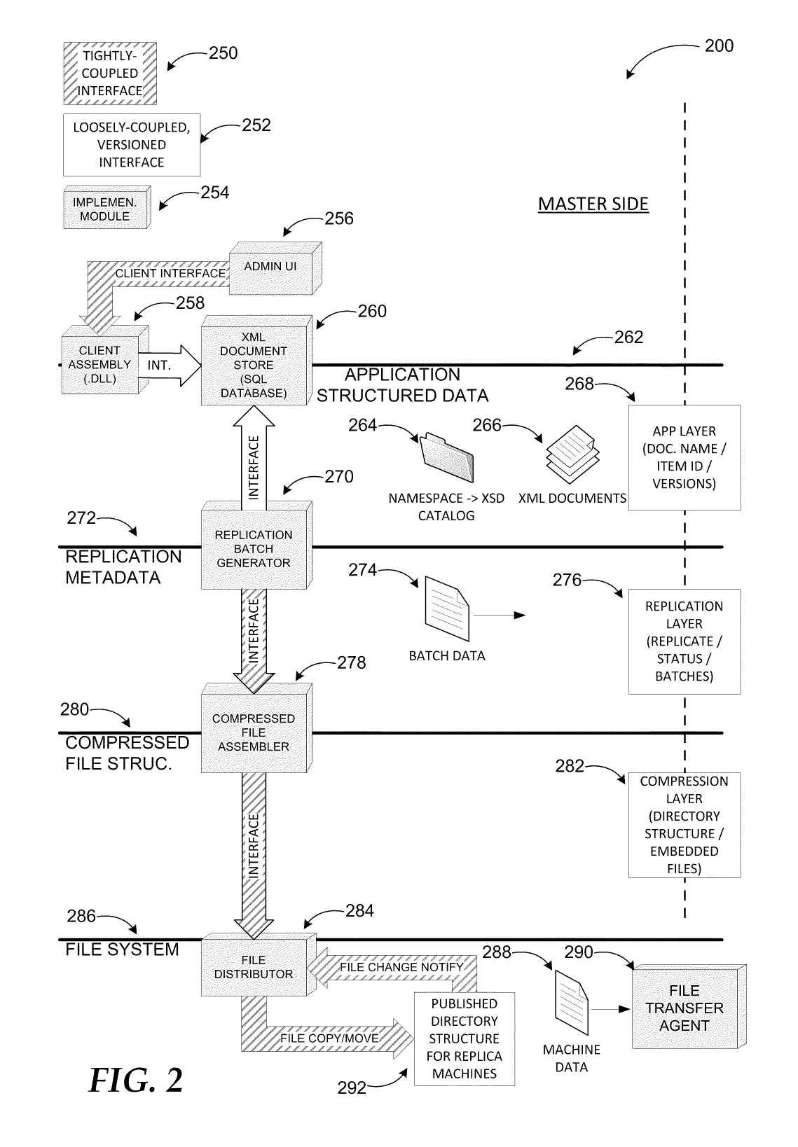

FIG. 2 illustrates the master side of an example replication model of structured document store layers according to embodiments. The structured document store layers for replicating server configurations in a distributed server system may include two sections: a master side (central configuration store) and a replica side (machines). The central configuration store is a singleton. Diagram 200 shows an example model for the master side. Data layers may include application structured data 262, replication metadata 272, compressed file structure 280, and file system 286.

An admin user interface 256 may enable administrators to interact with the structured (e.g. XML) data store 260 such as an SQL database through client library 258. A replication batch generator 270 between replication layer 276 and application layer 268 may generate batch data 274 containing configuration information and interface with structured document store 260 and compressed file assembler 278 between the replication layer 276 and compression layer 282. Application layer 268 may be responsible for maintaining document names, item identifiers, versions, etc.). Replication layer 276 is responsible for replication data, status updates, and generation of batches. Compression layer 282 generates the compressed data file (machine data 288) along with the directory structure and information about embedded files.

File distributor 284 at file system 286 may copy or move the configuration data file (machine data file 288) to published directory structure for replica machines 292 and receive notifications of changes. In diagram 200, elements with same background as legend element 250 represent tightly coupled interfaces, elements with same background as legend element 252 represent loosely coupled and versioned interfaces, and elements with same background as legend element 254 represent implementation modules.

When a configuration document is stored in the central store, it is assigned to a batch (274). Each batch may have a globally unique identifier and can hold multiple documents (266). Each batch may have a minor and major version. When a document is inserted to a batch or when a document in a batch is modified, minor version may be incremented. Major version may be incremented when a document is removed from the batch. Central configuration store may have a list of machines 292 in the deployment. The list may be updated by a master replication agent service through reading topology configuration data defined by system administrator (through admin user interface 256). Central configuration store may also store replication statuses for the machines.

Master replication agent service may periodically query the central configuration store to see if there is any machine which is not up-to-date. For the initial iteration, query may return all configuration data to be sent to all machines in the deployment. Master replication agent service may then create compressed files (e.g. zip) and place them under pre-configured directories. Each machine may have its own sub-directory. The machine data file 288 may include existing batches in central store along with their identifier, minor version, major version, and any documents held in the batches. File transfer agent 290 may monitor changes on these directories and pick up the machine data file 288 when it becomes available. File transfer agent 290 may read the topology configuration to determine which transfer method to use (file copy, http, manual, etc.). It may then push the machine data file 288 to a pre-configured file share on the replica machine.

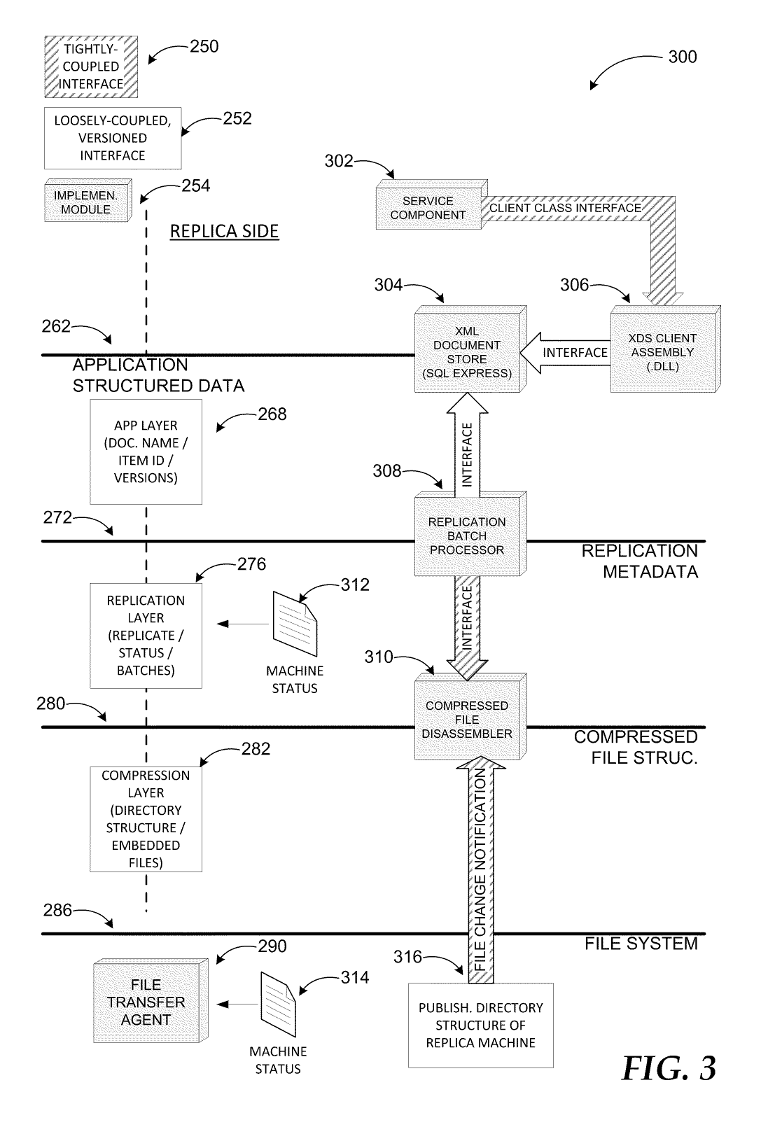

FIG. 3 illustrates the replica side of an example replication model of structured document store layers according to embodiments. Diagram 300 shows an example model for the replica side. Data layers include, as in diagram 200, application structured data 262, replication metadata 272, compressed file structure 280, and file system 286. Application, replication, compression layers (268, 276, and 282) and file transfer agent 290 also represent the same functionality as in FIG. 2.

File change notifications retrieved from machine data file 314, which is posted to published directory structure of the replica machines 316, are provided through a compressed file disassembler 310 at the compressed file structure 280 to replication batch processor 308. Replication batch processor 308 may retrieve the new configuration information and store as a structured document (e.g. XML) in local structured document store 304. Service component 302 may interface with the local structured document store 304 for implementing the changes to the local machine. Replication batch processor 308 may also provide a machine status 312 to the central configuration service through replication layer 276.

As mentioned above, a replica replication agent service may monitor for file change notifications on its local file share. It may process the machine data file 288 when it is posted by file transfer agent (or a manual copy or through http, etc.). The replica replication agent may update its local database with the data inside machine data file 288 and then generate a status report (e.g. a compressed status.zip file) and put it under its own local share. The status report may contain the batches at the particular replica machine with their identifiers, minor and major versions. It may not contain the document that batches hold.

File transfer agent 290 may monitor change notifications on each replica share (published directory structure of replica machine 316). When it detects a status report being posted, file transfer agent 290 may transfer the status report to master replication agent service file share under proper replica machine directory. Once the master replication agent service receives a status update, it may update the replica machine's status in central configuration store.

While these operations are in progress, master replication agent may periodically query central configuration store to determine if there is any not up-to-date replica machine. Master replication agent may compare replica status with current central configuration store status and generates a data file accordingly for a new round of updates.

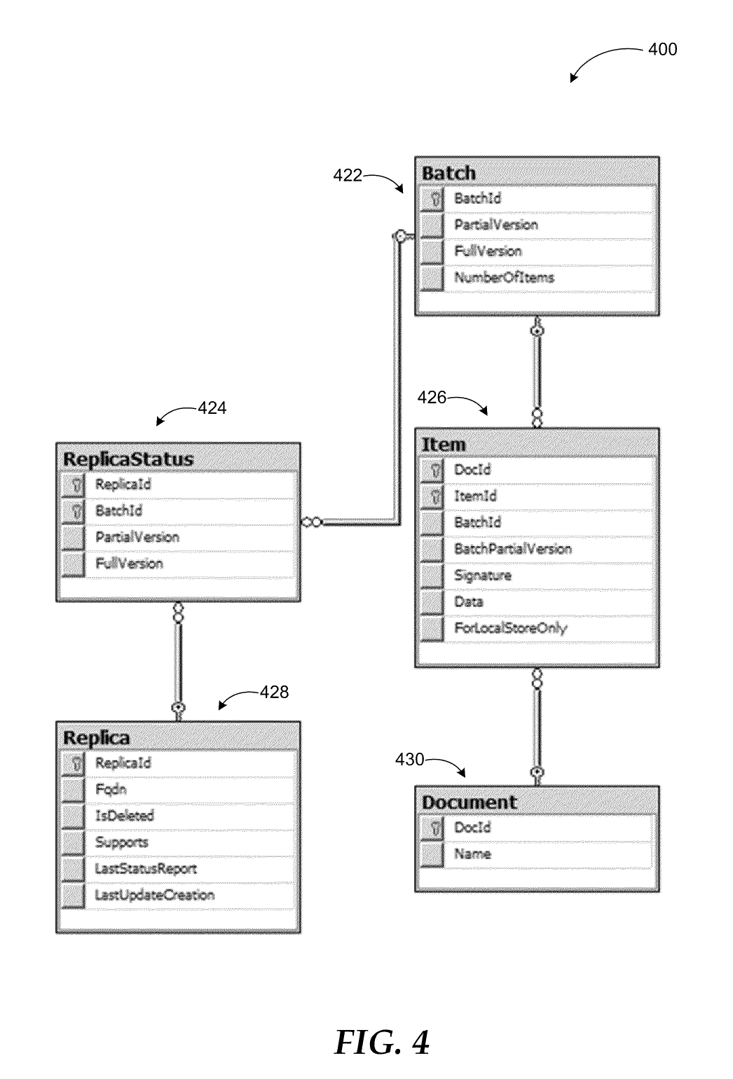

FIG. 4 is an example replication database diagram for replicating server configuration in a distributed server system. Each item 426 in the replication database may include a document identifier, an item identifier, and a batch identifier, along with batch partial version and data associated with the item. Item 426 may also include a signature for identifying changes in XML data and providing multi-thread writes on the same data. If two administrators read the same configuration and attempt to change it, one may succeed. The other may get a signature conflict error, and be forced to re-read the latest document and re-publish it. Each batch 422 may include a batch identifier, a partial and a full version (minor & major versions), and a number of associated items. Document 430 may include a document identifier and the document name.

Replica status object 424 may include a current replica identifier, a batch identifier associated with the current replica, and major and minor versions of the current batch. The replica identifier may be provided from replica object 428, which may include the replica identifier, a fully qualified domain name (FQDN) for the machine, and additional information such as when the last status report was created, when the last update was created, and/or replica version.

As discussed above, configuration replication is achieved through a machine data file that is sent to out-of-date machines by the central configuration service. The data included in the machine data file may be determined by applying following logic:

(1) If a replica machine has all the batches with same minor and major versions, replica is up-to-date. Therefore, there is no need to generate a data file for that particular replica machine.

(2) If there is a new batch in central configuration store, which does not exist in the replica machine, the machine data file includes the batch with all its documents in it.

(3) If there is a batch removed from central management store, which still exist in the replica machine, the machine data file includes the identifier of the no-longer-existing batch without any documents in it. This is a way to tell the replica machine that everything in this batch is removed, and the batch should be removed too. Replica machine may then take proper actions and generate a status report with the batch removed.

(4) If there is a batch in central configuration store with higher minor version than the one in a replica machine, then the machine data file includes all the documents that are added or modified after the minor version indicated by replica batch and current minor version in central configuration store.

(5) If there is a batch in central configuration store with higher major version than the one in a replica machine, then the machine data file includes all the documents that the batch includes. This is a way to tell the replica machine that some document(s) has been deleted from this batch. Since no place holders are kept for deleted objects, the replica machine does not know what to delete. Therefore, the machine data file includes all current documents for this batch so that the replica machine can delete what it has and apply the latest from the machine data file. Since a single document deletion may cause other documents in same batch to be sent to the replica machines, the correct the number of documents in a given batch may be determined first. Various batch management algorithms may be employed according to the nature of the configuration data such as size based batching, number of item based batching, etc.

When a replica receives the full update for a given batch, it may add/update the documents in the received batch and delete any documents that are not listed in the received update. A number of items based model may be used, where the current number of items in the received update, local database, and refresh replication for the batch may be compared if there is a mismatch. This way, the system may be protected against cases where the replica side is manually updated for any reason while central store is not aware of the change. Yet another mechanism that may be employed includes sending the current state when the replica agent starts up. This may ensure replica and master are synchronized when a replica starts up.

The replica replication service may generate a status report without processing a machine data file when it starts up (to ensure local configuration store did not get updated while the replica replication service was down) or when it detects that the local configuration store has been de-attached, re-attached, or restored from an out of date backup, etc. In a system according to embodiments, the configuration data may be replicated from a single server or a cluster. As discussed previously, the replication is transactional. Thus, the configuration document is replicated or not. There are no differential documents.

The example systems in FIG. 1 through 4 have been described with specific components such as registrar servers, communication servers, directory servers, presence servers, and the like. Embodiments are not limited to distributed server systems according to these example configurations. Furthermore, specific protocols are described for communication between different components. Embodiments are also not limited to the example protocols discussed above, and may be implemented using protocols, components, and configurations other than those illustrated herein employing fewer or additional components and performing other tasks.

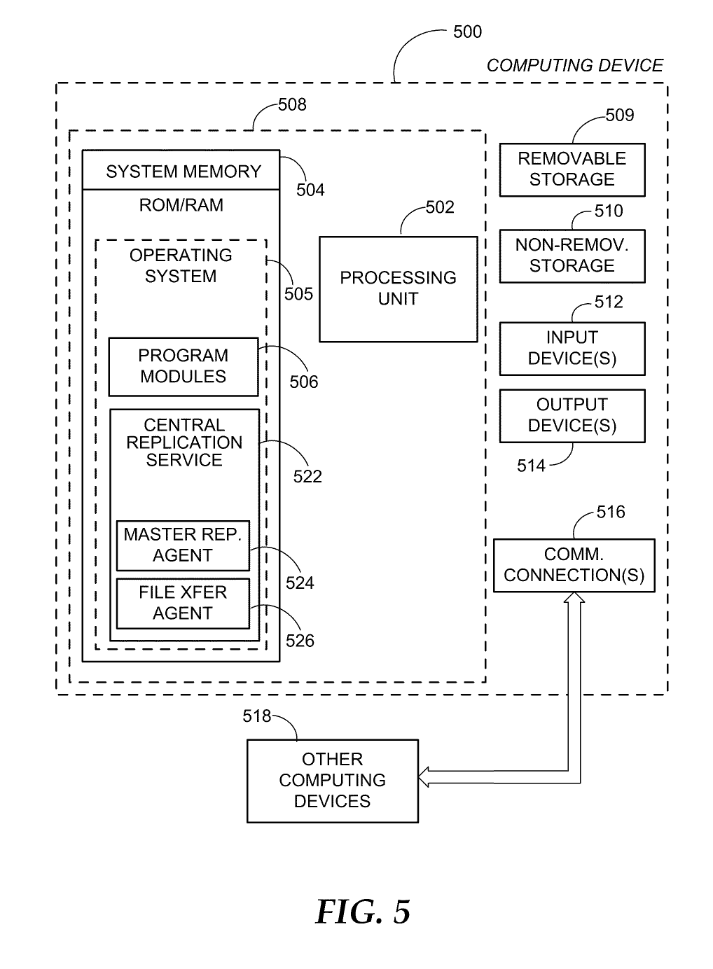

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be a management server within a distributed server system and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506 and central replication service 522 with master replication agent 524 and file transfer agent 526.

Central replication service 522 may store, update, and manage system topology and configuration. Master replication agent 524 and file transfer agent 526 may be responsible for replicating configuration data within batches to other machines in the system in conjunction with replica replication agents running on individual machines. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, other directory or policy servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

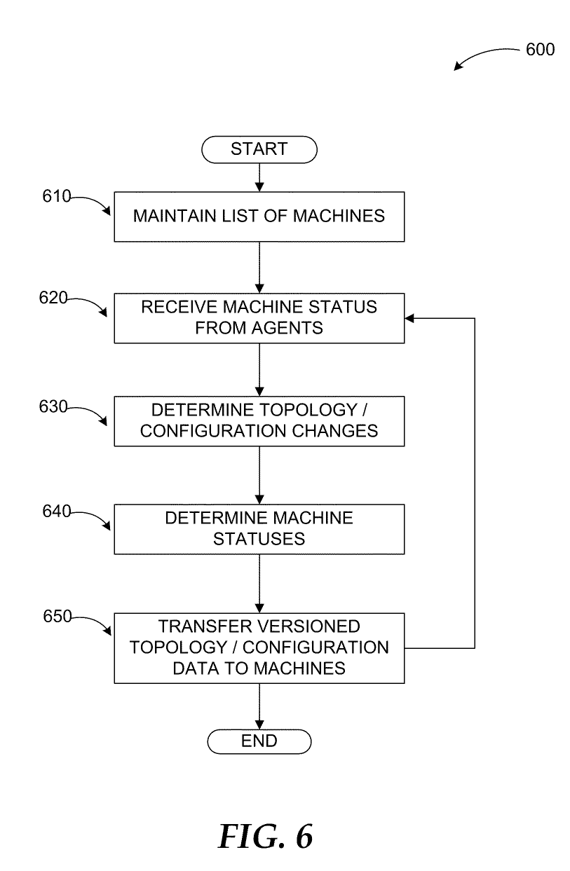

FIG. 6 illustrates a logic flow diagram for process 600 of replicating server configuration in a distributed server system according to embodiments. Process 600 may be implemented as part of an enhanced communication or similar system.

Process 600 begins with operation 610, where the central replication service maintains a list of machines and their configurations. At operation 620, status of individual machines may be received from replica replication agents or similar mechanisms at those machines. Replication of the configuration data and monitoring of the status of the machines in the system is a continuous process, where upon receiving an update each machine provides their status to the central replication service. Thus, if a machine is determined to be out of sync with the master configuration, the cycle of update may begin again for that machine.

At operation 630, topology, configuration, and/or policy changes within the system may be determined by the central replication service. Topology includes aspects of the system such as which machines are involved, which server roles are installed on each machine, dependencies, etc. Configuration includes non-user specific settings for the servers. At operation 640, the status of individual machines is determined (whether they are synchronized or not with the master configuration). Then, at operation 650, versioned configuration data may be sent to the machines using batches as described previously. Once a machine receives and successfully installs the new configuration, it may send its updated status to the central replication service such that the cycle can begin again.

The operations included in process 600 are for illustration purposes. Replication of configuration data in distributed server systems according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for replicating configuration data in distributed server systems, the method comprising:
receiving a configuration status report from a replica component of a distributed server system;
determining a current configuration associated with the system at a central configuration store;
determining the replica component's current status based on comparing the received configuration status report to the current configuration at the central configuration store; and
transferring a versioned configuration data file to the replica component such that the configuration of the replica component is synchronized with the current configuration at the central configuration store, wherein the configuration data file is tailored to the replica component.

2. The method of claim 1, wherein transferring the versioned configuration file includes:
assigning a configuration document reflecting the current configuration to a globally identifiable batch;
placing updated batches for out-of-date components into respective sub-directories in a published directory structure for replica components;
upon detecting a batch in a sub-directory, transferring the versioned configuration data file to a local directory at the replica component such that configuration changes included in the batch are implemented at the replica component.

3. The method of claim 2, wherein each batch includes a batch identifier, a major version, and a minor version.

4. The method of claim 3, wherein the major version is incremented in response to a configuration document being removed from a batch, and the minor version is incremented in response to one of: an existing configuration document being modified and a new configuration document being added to the batch.

5. The method of claim 1, further comprising:
compressing the configuration data file prior to transferring, wherein the configuration data file is formatted in a markup language structure.

6. The method of claim 1, wherein the configuration data file is transferred through one of: an automatic file copy, a hypertext transfer protocol (http) transfer, and a manual copy.

7. The method of claim 1, wherein the central configuration store maintains a status list of replica components based on received configuration status reports, and the method further comprises:
periodically querying the status list to determine replica components to be synchronized.

8. The method of claim 1, wherein the configuration data includes at least one from a set of: identifiers of replica components, roles assigned to each replica component, dependencies between replica components, and settings for replica components.

9. The method of claim 1, wherein the status report includes a batch stored at the replica component, the batch's identifier, and the batch's versions.

10. The method of claim 1, wherein the configuration data file includes a batch intended for the replica component, the batch's identifier, the batch's versions, and at least one configuration document associated with the batch.

11. The method of claim 1, further comprising:
enabling a replication agent at the replica component to retrieve the configuration data file from a local directory, decompressing the configuration data file, and updating a local configuration database such that a local service component is enabled to implement the current configuration at the replica component.

12. The method of claim 1, further comprising:
receiving status reports from replica components into respective sub-directories associated with each replica component following transfer of an updated configuration data file.

13. A distributed server system replicating configuration data to replica components, the system comprising:
a server configured to:
manage a central configuration store maintaining a status list of replica components based on received configuration status reports and a current topology document defining at least one from a set of: identifiers of replica components, roles assigned to each replica component, and settings for replica components;
execute a master replica agent configured to:
periodically query the status list to determine replica components to be synchronized;
assign at least one current topology document tailored to a replica component to a batch;
place updated batches for replica components to be synchronized into respective sub-directories in a published directory structure for replica components; and
execute a file transfer agent configured to:
upon detecting a batch in a sub-directory, transfer a versioned configuration data file comprising the batch and associated current topology documents to a local directory at the replica component such that configuration changes included in the batch are implemented at the replica component; and
transfer a status report from the replica component following implementation of the configuration changes to the sub-directory.

14. The system of claim 13, wherein the central configuration store is a structured store that includes at least one from a set of: an application layer for maintaining document names, item identifiers, and versions; a replication layer for processing replication data, status updates, and generating batches; and a compression layer for generating a compressed configuration data file that includes directory structure and information about embedded files.

15. The system of claim 13, wherein the master replica agent is further configured to:
if a new batch exists in the central configuration store without a corresponding batch at a replica component, including the new batch and associated configuration documents in the configuration data file.

16. The system of claim 13, wherein the master replica agent is further configured to:
if an existing batch is removed from the central configuration store with a corresponding batch still existing at a replica component, including an identifier of the removed batch without any documents in the configuration data file; and
if a batch in the central configuration store includes a higher minor version than a minor version of a corresponding batch in a replica component, including configuration documents added or modified after the minor version indicated by the corresponding batch at the replica component.

17. The system of claim 13, wherein the master replica agent is further configured to:
if a batch in the central configuration store includes a higher major version than a major version of a corresponding batch at a replica component, includes configuration documents associated with the batch in the central configuration store in the configuration data file.

18. A computer-readable storage medium with instructions stored thereon for replicating configuration data in distributed server systems, the instructions comprising:
managing a central configuration store maintaining a status list of replica components based on received configuration status reports and a current configuration document defining at least one from a set of: identifiers of replica components, roles assigned to each replica component, and settings for replica components;
periodically querying the status list to determine replica components to be synchronized;
assigning at least one current configuration document tailored to a replica component to a batch;
placing updated batches for replica components to be synchronized into respective sub-directories in a published directory structure for replica components;
upon detecting a batch in a sub-directory, transferring a compressed and versioned configuration data file comprising the batch and associated current configuration documents to a local directory at the replica component such that configuration changes included in the batch are implemented at the replica component; and
transferring a status report from the replica component following implementation of the configuration changes to the sub-directory.

19. The computer-readable medium of claim 18, wherein the distributed server system is an enhanced communication system, the configuration documents are extensible markup language (XML) documents, and the central configuration store is maintained at a management cluster of the enhanced communication system.

20. The computer-readable medium of claim 18, wherein the status report is further received from the replica component following one of: activation of a local replication agent at the replica component, de-attachment of a local configuration store at the replica component from the system, and re-attachment of a local configuration store at the replica component to the system.
